(19) United States
(12) Patent Application Publication
(10) Pub. No.: US 2009/0056077 A1
(43) Pub. Date: Mar. 5, 2009

(54) HINGED FASTENER FOR SHOWER DOORS

(76) Inventors: Philippe BELANGER, Montreal (CA); Denis BERNIER, Mascouche (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/848,653

(22) Filed: Aug. 31, 2007

(51) Int. Cl. E05D 15/06

(52) U.S. Cl. 16/364

(57) ABSTRACT

A hinged fastener for a shower door having two juxtaposed door panels. The hinged fastener comprises two hinge portions each adapted to be attached to one of the two door panels, the hinge portions being pivotally connected to one another and pivoting about a hinge pivot axis located between the two door panels to form a hinge; and at least one mounting assembly pivotally connected to a mounting pivot axis, parallel to the hinge pivot axis, the mounting assembly pivoting about the mounting pivot axis, independently of the hinge portions, the mounting assembly being engaged with a shower rail for simultaneous displacement of the door panels of the shower door relative to the shower rail. The hinge pivot axis can be the mounting pivot axis and there can be a single mounting assembly. The mounting assembly can further comprise a roller assembly or a displacement assembly.

### BACKGROUND OF THE INVENTION

1. Field of the Invention

The invention relates to shower doors and more particularly, to fasteners used to slide the panels of a shower door.

2. Description of the Prior Art

Corner showers, adapted to be installed in a corner of the room, typically have hinged doors which open toward the exterior of the shower, thereby creating a passageway to enter the shower. Corner showers are more space-efficient since they only take up a typically vacant space in the bathroom. However, the hinged door requires a considerably large empty space facing the corner shower. Corner showers can have a round rail or an angled rail.

In some corner showers, there are two fixed panels and two sliding panels forming doors which are held in a rail at the top and the bottom of the shower and a handle or frame is provided on the door(s) to slide them and create a passageway to enter the shower.

Other corner showers have four sliding panels with two fixed panels for wide and easy central access to the shower. The four sliding panels are provided as two hinged panels for each side and the opening is created in the middle. Rollers are typically mounted on a single panel of each side and the second hinged panel simply follows the one with the rollers. Two rollers at the top and two rollers or guides at the bottom are typically used for each leading panel. The disadvantage of this system is mainly the misalignment of the leading and lead panels which can eventually make it difficult to slide the panels without having the re-adjust the alignment of the panels.

### SUMMARY OF THE INVENTION

One aspect of the invention provides for a hinged fastener for a shower door having two juxtaposed door panels. The hinged fastener comprises two hinge portions each adapted to be attached to one of the two door panels, the hinge portions being pivotally connected to one another and pivoting about a hinge pivot axis located between the two door panels to form a hinge; and at least one mounting assembly pivotally connected to a mounting pivot axis, parallel to the hinge pivot axis, the mounting assembly pivoting about the mounting pivot axis, independently of the hinge portions, the mounting assembly being engaged with a shower rail for simultaneous displacement of the door panels of the shower door relative to the shower rail.

The hinge pivot axis can be the mounting pivot axis.

There can be a single mounting assembly.

The mounting assembly can further comprise a roller assembly or a displacement assembly.

### BRIEF DESCRIPTION OF THE DRAWINGS

Further features and advantages of the present invention will become apparent from the following detailed description, taken in combination with the appended drawings, in which:

FIG. 1 shows a round corner shower having two fixed panels and four sliding panels;

FIG. 2 shows an exploded view of a round shower of the type of that shown in FIG. 1;

FIG. 3 comprises FIG. 3a and FIG. 3b, wherein FIG. 3a shows a round corner shower in which the sliding panels are in the closed position and FIG. 3b shows the corner shower of FIG. 3a with the sliding panels in the open position;

FIG. 4 comprises FIG. 4A, FIG. 4B and FIG. 4C, wherein FIG. 4A is a side perspective view of a double roller of the prior art inserted in the prior art rail of a corner shower, FIG. 4b is a side perspective view of the double roller of FIG. 4A and of the panel adapter and FIG. 4C is a side perspective view of the sliding panel inserted in the top and bottom prior art rails of a corner shower using the double roller of FIG. 4A at the top and single rollers of the prior art at the bottom;

FIG. 5 comprises FIG. 5A and FIG. 5B, wherein FIG. 5A is a front plan view which shows the top of the two slidable panels with a double hinged roller and two double prior art rollers and FIG. 5B is a top plan view of the top of the two slidable panels of FIG. 5A with the double hinged roller and the two double prior art rollers;

FIG. 6 comprises FIGS. 6A, 6B, 6C and 6D, wherein FIG. 6A is a front perspective view of a double hinged roller in assembled configuration, FIG. 6B is an exploded view of the double hinged roller of FIG. 6A, FIG. 6C is a cross-sectional view of a portion of the double hinged roller of FIG. 6A attached to the panel, FIG. 6D is a back perspective view of the double hinged roller FIG. 6A;

FIG. 7 comprises FIG. 7A and FIG. 7B, wherein FIG. 7A is a front plan view which shows the bottom of the two slidable panels with a single hinged roller and two single prior art rollers and FIG. 7B is a top plan view of the bottom of the two slidable panels of FIG. 7A with the single hinged roller and the two single prior art rollers;

FIG. 8 comprises FIGS. 8A, 8B, 8C and 8D, wherein FIG. 8A is a front perspective view of a single hinged roller in assembled configuration, FIG. 8B is an exploded view of the single hinged roller of FIG. 8A, FIG. 8C is a cross-sectional view of a portion of the single hinged roller of FIG. 8A attached to the panel, FIG. 8D is a back perspective view of the single hinged roller FIG. 8A;

FIG. 9 is a side plan view of the double hinged roller affixed to the top of a slidable panel and of the single hinged roller affixed to the bottom of the same panel, both rollers being inserted in a corresponding top and bottom rail of the shower.

FIG. 10 is a side perspective view of a single hinged roller provided with adapters for affixing the single hinged roller to the panels using a pin;

FIG. 11 comprises FIGS. 11A and 11B, wherein FIG. 11A is side perspective view of an embodiment of the double hinged roller comprising snap-on protrusions for snapping into female elements of the sliding panels and FIG. 11B is a side elevation view of one portion of the snap-on double hinged roller of FIG. 11A with the sliding panel snapped in place; and

FIG. 12 comprises FIGS. 12A and 12B, wherein FIG. 12A is a side perspective view of an embodiment of the hinged fastener having a un-wheeled displacement assembly and FIG. 12B is a cross-sectional view of the hinged fastener of FIG. 12A wherein the displacement assembly is received in a rail of the shower.

It will be noted that throughout the appended drawings, like features are identified by like reference numerals.

### DETAILED DESCRIPTION

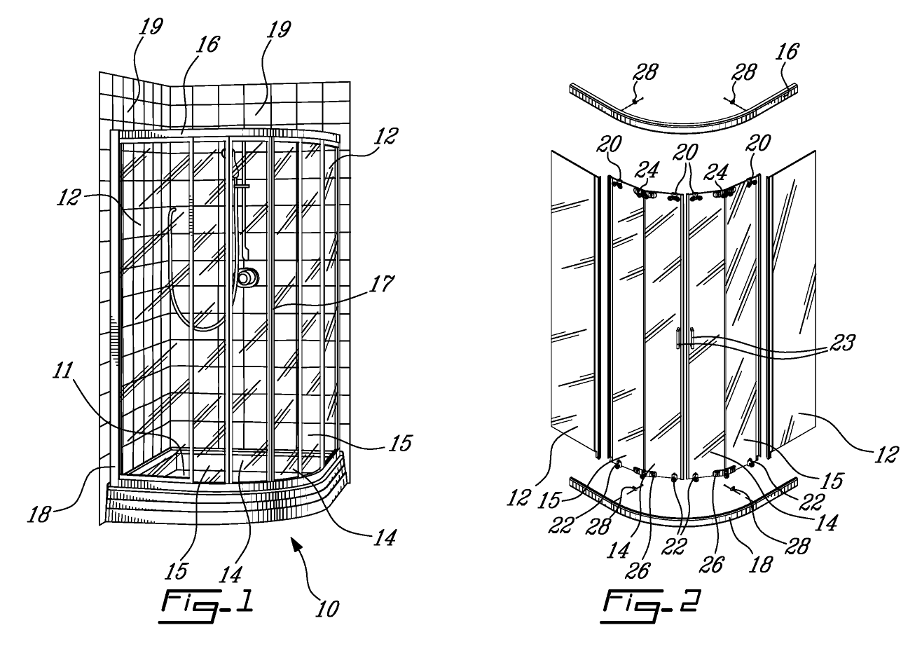

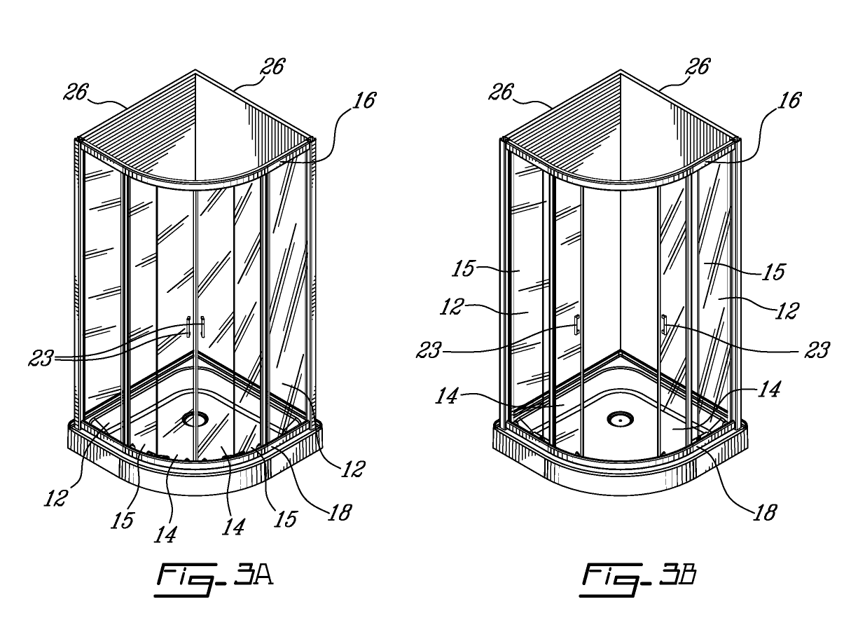

FIG. 1 shows a round corner shower 10 having two fixed panels (front walls) 12 and four sliding panels (doors) 14, 15. The sliding panels 14, 15 slide in a top shower track or rail 16 and a bottom shower track or rail 18. A frame 17 is provided on one side of the center sliding panels to allow displacement of the sliding panels. In this round corner shower, the walls and doors are made of glass in an aluminum structure and are translucid. The corner shower structure rests against two walls 19 forming a corner of the room. FIG. 2 is an exploded view of a round shower of the type of that shown in FIG. 1. On FIG. 2, the rollers used to slide the slidable panels 14, 15 are apparent. The slidable panels are grouped into two doors of two panels each. A door is composed of a handle panel 14 and a wall panel 15. In FIG. 2, the handle panel 14 is provided with a handle 23. The top of the door is provided with three rollers, namely two prior art double rollers 20 one at each corner of the door and one double hinged roller 24 joining the two panels 14, 15 of the door. At the bottom of the door, there are three rollers, namely two prior art single rollers 22 one at each corner of the door and one single hinged roller 26 joining the two panels 14, 15. The user uses door frame 24 or handles 23 to slide the doors. The corner shower has a bottom recipient 11 for draining the waste water. The shower can have a roof (not shown) or can be roofless.

The round tracks 16, 18 each comprise three portions, namely two straight portions (a right-side insert and a left-side insert) and one curved portion. The tracks 16, 18 are preferably equipped with bumpers 28 affixed to the straight track portions to prevent the rollers holding the sliding doors from reaching the end of the tracks 16, 18 and prevent bumping of the sliding panels on the side walls of the shower.

As shown in FIG. 3, the four slidable panels (doors) 14, 15 are adapted to be rolled in a closed position (FIG. 3A) and in an open position (FIG. 3B) by being guided in top 16 and bottom 18 round tracks using double rollers 20, 24 and single rollers 22, 26. The shower can further have two back walls 26 making up the corner which are typically affixed to existing walls 19 of the room. These back walls can be omitted if the existing walls of the room are covered in an appropriate water-proof material, such as tiling, for a shower. If they are omitted, appropriate seals should be provided at the junction of the fixed walls of the shower with the existing walls.

In the preferred embodiment illustrated in FIGS. 1-3, the total height of the shower could vary between 170 cm to 185 cm. The sliding panels of the doors could have a height which varies between 175 cm to 180 cm. All the glass panels used for these doors could vary from 3 mm to 10 mm of thickness. The width of the shower can vary from 32 in to 42 in. The straight portions of the track 16 each have a length varying from 12 to 17 inches depending on the width of the shower. The curved portion of the track 16 has a length varying from 15 to 22 inches. The curved portion creates an angle of about 45 degrees.

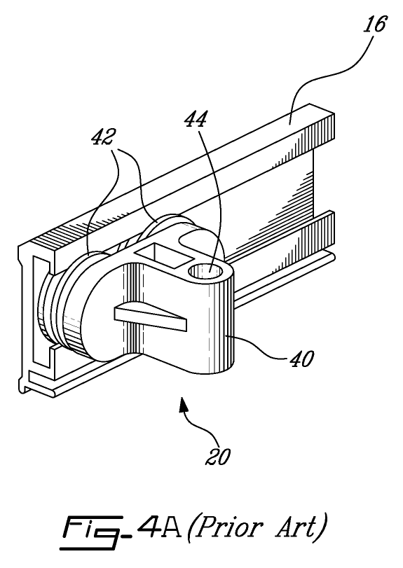

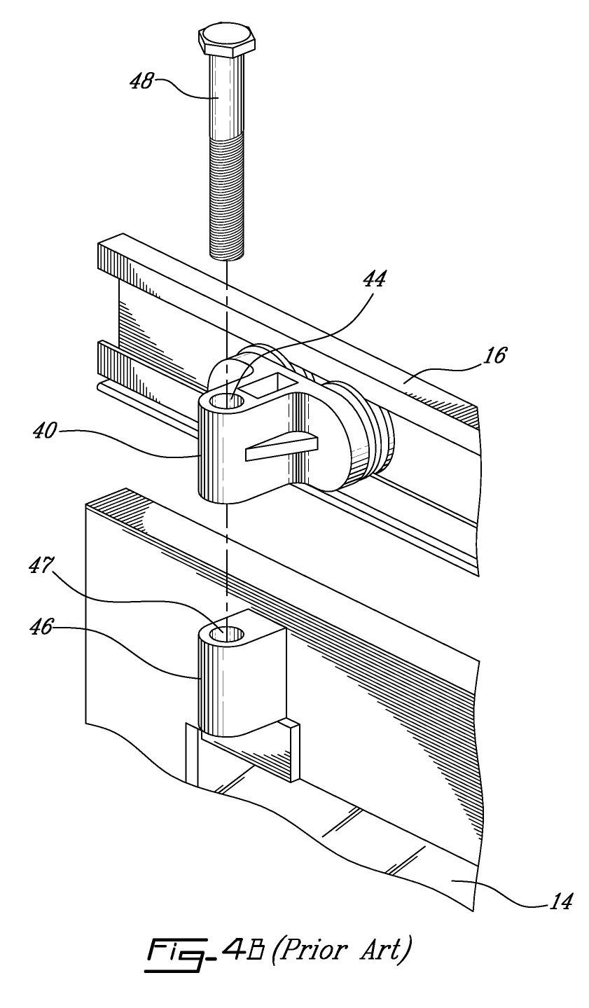

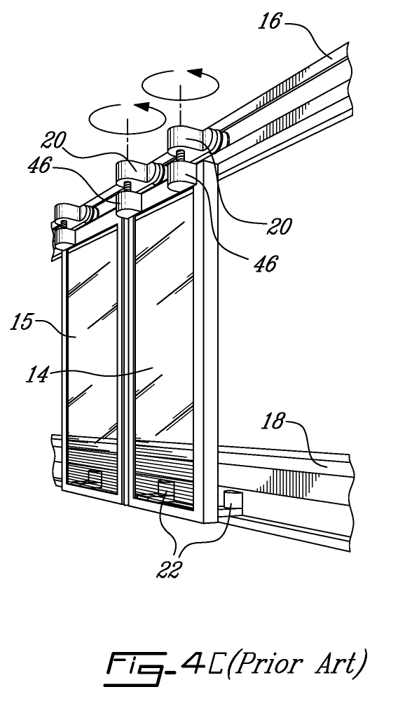

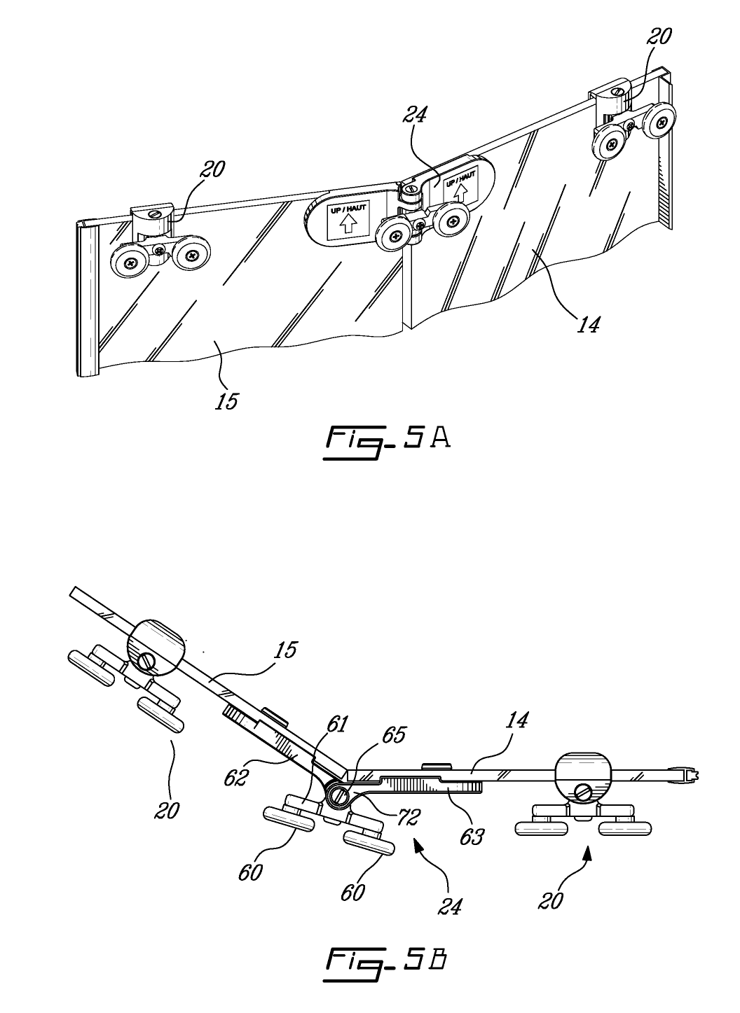

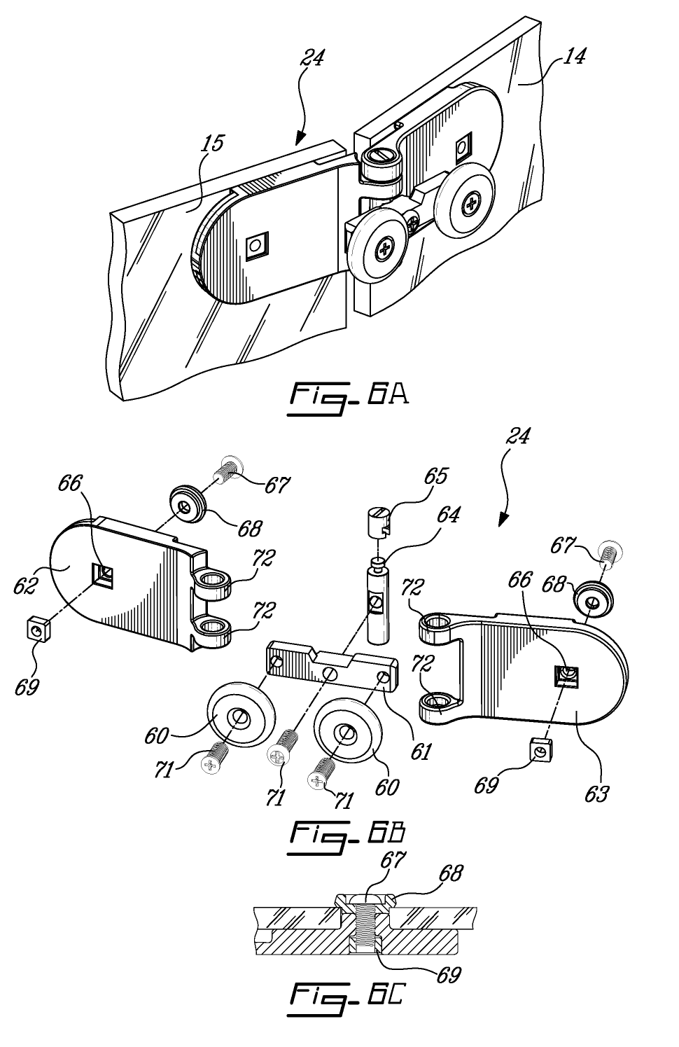

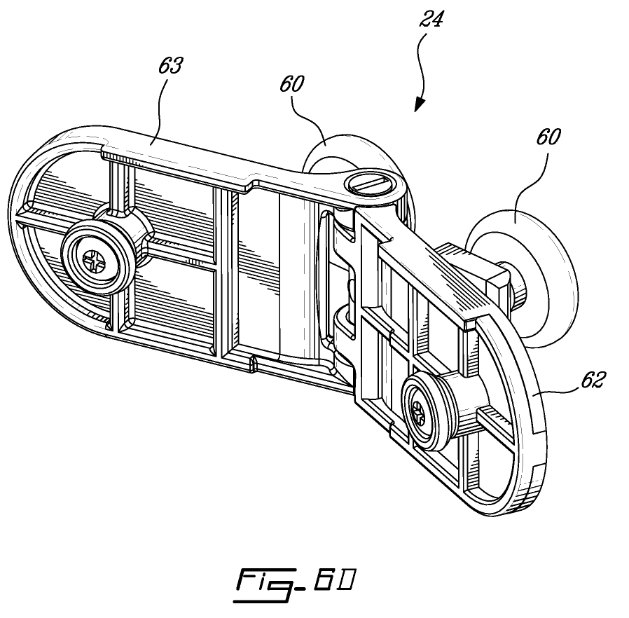

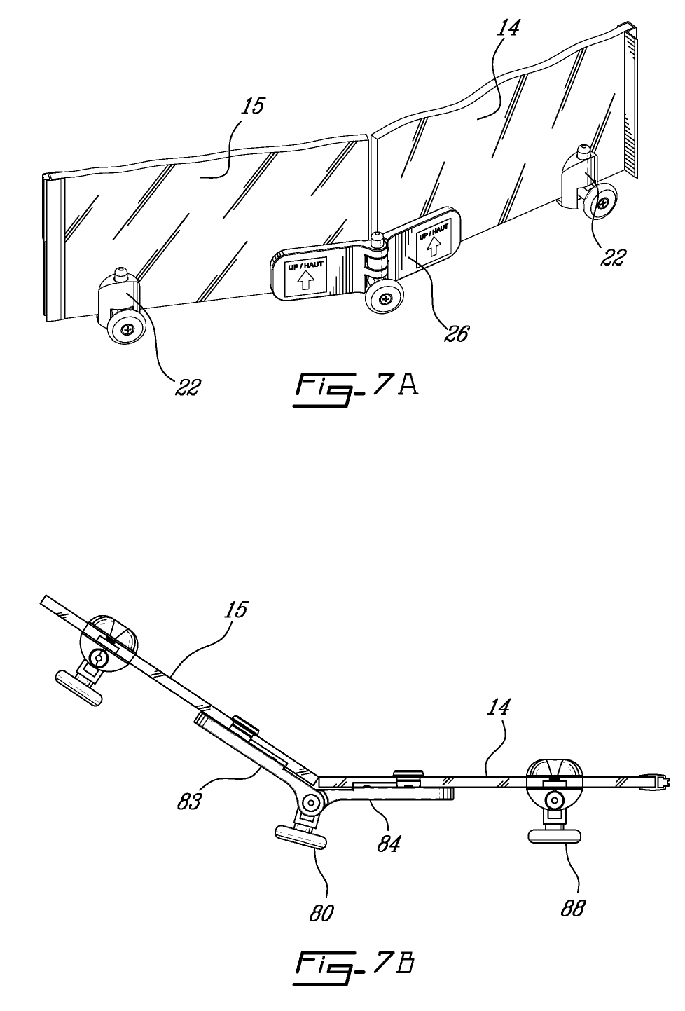

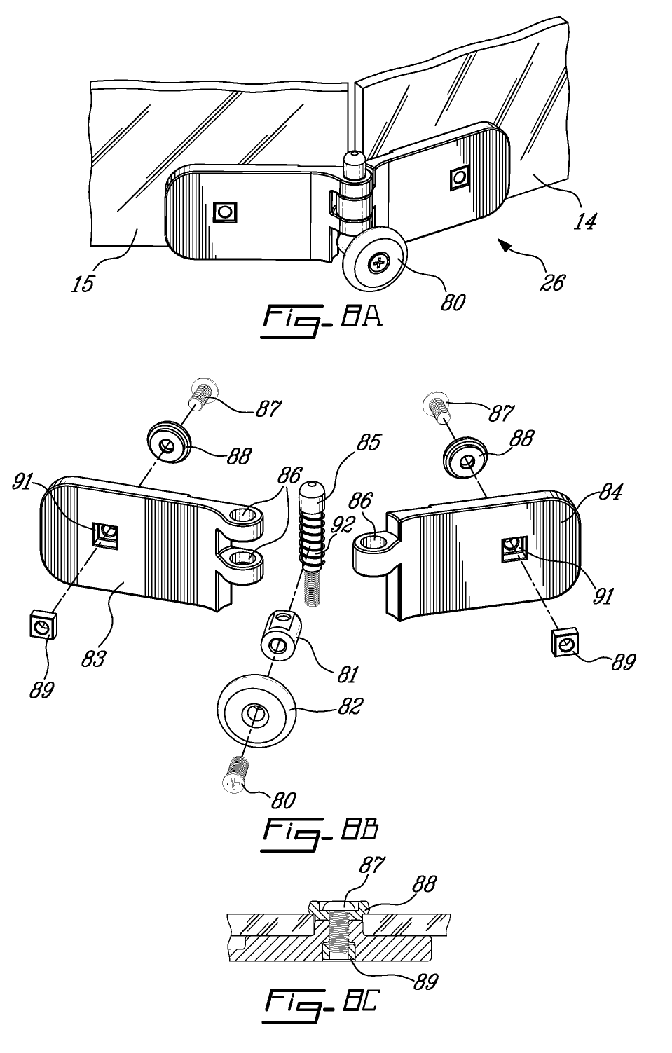

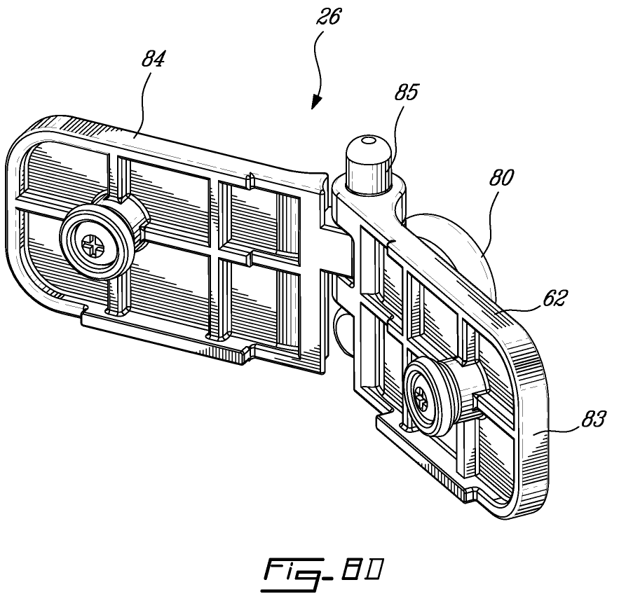

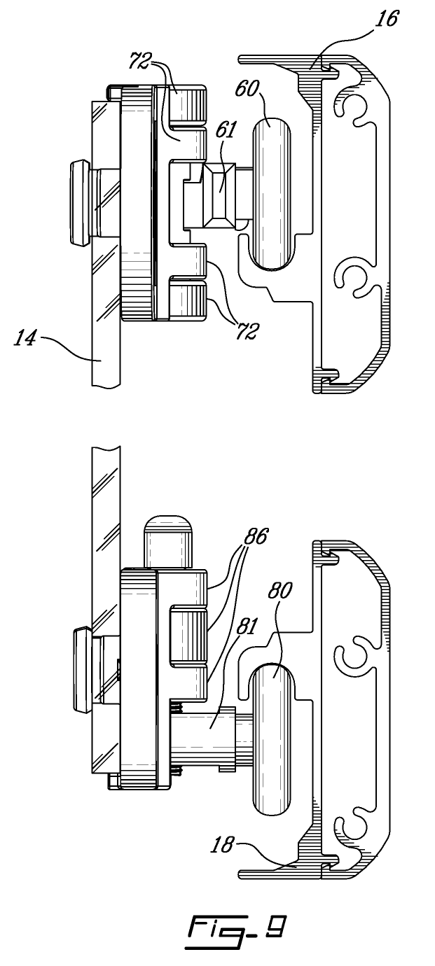

In prior art shower doors, shown in FIG. 4, the four sliding panels are provided as two hinged panels for each side and the opening is created in the middle. Two rollers or guides are typically mounted on a single panel 14 of each door and the second hinged panel 15 simply follows this first panel, being supported with only one roller or guide. Alternatively, both panels of each door can be provided with rollers. Two rollers at the top and two rollers at the bottom are typically used for each leading panel.

FIG. 4A is a side perspective view of a double roller of the prior art inserted in the prior art rail of a corner shower. The double roller 20 is inserted in the interior portion of the track 16. It comprises a roller body 40 and two wheels 42. The roller body 40 is adapted to protrude from rail 16 and the wheels are retained within track 16 to let the roller slide in the track. Roller body 40 is provided with a female member 44, in this case, a vertical cylindrical passage. As shown in FIG. 4B, the female member 44 allows to fasten the prior art double roller to the shower door using a male member, typically a screw 48 which is inserted in both the female member 44 of the double roller body 40 and a female member 47 of door roller adapter 46. The female member 47 is, in this case, a vertical cylindrical passage which may be threaded, provided on a frame surrounding the sliding panel 14. FIG. 4C is a side perspective view of the sliding panel 14 inserted in the top 16 and bottom 18 prior art rails of a corner shower using the double roller 20 of FIG. 4A and prior art single rollers 22.

The hinged fastener is for a slidable door which has at least two panels 14, 15 which partly fold and slide to create a passageway to enter the shower. The hinged fastener can be a hinged roller provided with one or two wheels and will be called double hinged roller if it has two wheels and single hinged roller if it has one wheel. If the hinged fastener does not have a roller assembly, it can alternately have a displacement assembly which allows to slide the doors without the use of wheels. Both the roller assembly and the displacement assembly are mounted on the hinged fastener using a mounting assembly.

In the present description, a hinge is defined as two movable plates attached together and each attached to a panel. It allows the panels to pivot about one another. The plates are also referred to as leaves and/or hinge portions. The hinge portions typically include one or more knuckles. The barrel is an enlarged portion of the hinge adapted to receive a pin and act as the pivot point. It is formed by the knuckles.

As shown in the figures, the double hinged roller is preferably provided at the top of the panel for increased stability and ease of displacement and the single hinged roller is provided at the bottom of the panel. However, as will be readily understood by one skilled in the art, the single and double hinged rollers could be used on any or on both ends of the panel. Preferably, the double hinged roller is accompanied by double prior art rollers at the other top corner of each panel and the single hinged roller is accompanied by single prior art rollers at the other bottom corner of each panel. A double hinged roller could be accompanied by single prior art rollers and vice-versa. Also, all accompanying rollers could be prior art rollers (single or double). It should be noted that only one hinged roller may be used to allow displacement of the slidable panels at the top or at the bottom of the panels. At the other end, only one hinged roller (double or single) and/or at least one prior art roller (double or single) may be used. Therefore, both the double hinged roller and the single hinged roller will be described in detail and at least one could be provided on slidable panels in combination with one another, with other ones of the same type or with prior art rollers, as per a design choice of the person skilled in the art.

FIG. 5 shows the top of two slidable panels with a double hinged roller and two double prior art rollers. The double hinged roller 24 joins the two panels 14, 15 together. The two double prior art rollers 20 help for the alignment of the door.

FIG. 6 shows the double hinged roller. In FIG. 6A, the double hinged roller 24 is installed on the door panels 14, 15. In FIG. 6B, the double hinged roller is shown in an exploded view. The double hinged roller has two wheels 60, a support bare 61, a left hinge portion 62, a right hinge portion 63, a pin 64 and a pin cap 65. The left and right hinge portions 62 and 63 have knuckles 72 which are positioned to create a passageway therethrough once the two portions are fitted into one another. Pin 64 can then be fitted in the passageway. Support bare 61 has three female members. Screws 71 or other fastening means are used to secure the wheels 60 to the female portions at the extremity of the support bare 61 and to secure the pin 64 to the middle female portion of the support bare 61. Once the pin 64 is fastened to the support bare 61, the pin cap 65 can be placed on the pin and the hinge cannot be dismantled without unfastening the pin from the support bare.

As shown in FIG. 6C, screws 67, plastic sleeves 68, nuts 69 and caps 70 or other fastening means are used to fasten the hinged roller to the shower panel via female portions 66 on left and right hinge portions and female portions on the door panels 14, 15. FIG. 6D is a back perspective view of the assembled double hinged roller.

The pin cap 65 is used to adjust alignment of the hinged roller with the track and alignment of the door panels within the shower. By threading the pin cap 65 on the pin 64, the support bare 61 is slightly displaced and thereby lifts or pulls on the door panels. It helps to compensate for the slight variations in inclination of the walls upon which the shower is affixed.

Once fastened to the door panels, the hinge portions can still pivot about the pin and can therefore allow partial folding of the door composed of the two door panels while ensuring that the door can be slid in the rail or track using the rollers. The hinged roller therefore allows the wheel assembly to pivot while traveling in the rail and allows the door panels to pivot and fold one with respect to the other. A single axis, namely the pin, allows this double articulation. This allows the fastener to closely follow the shape of the rail. It is especially useful for showers with rails having a shape other than a straight line, for example having a curved or S-shape. In all cases, especially if the fastener is to be used with angled rails, the relative dimensions of the pin cap 65, the pin 64, the support bare 61 will need to be adjusted as will be readily understood by one skilled in the art and an additional pin, potentially an expandable/retractable pin, connected to the support bare 61 may be required, for example, for each wheel to ensure proper traveling of the roller assembly in the rail.

FIG. 7 shows the bottom of two slidable panels with a single hinged roller and two single prior art rollers. The single hinged roller 26 joins the two panels 14, 15 together. The two single prior art rollers 22 help for the alignment of the door.

FIG. 8 shows the single hinged roller. In FIG. 8A, the single hinged roller 26 is installed on the door panels 14, 15. In FIG. 8B, the single hinged roller is shown in an exploded view. The single hinged roller has one wheel 80, a wheel support 81 which is affixed to the wheel using screw 82. The single hinged roller also has a left hinge portion 83, a right hinge portion 84, a spring pin 85 and a spring 92. The left and right hinge portions 83 and 84 have knuckles 86 which are positioned to create a passageway therethrough once the two portions are fitted into one another. Spring pin 85 can then be fitted in the passageway. The same screw 82 is used to screw the wheel support 81 to the spring pin 85. The hinge cannot be dismantled without unfastening the pin from the wheel.

As shown in FIG. 8C, screws 87, plastic sleeves 88, nuts 89 and caps 90 or other fastening means are used to fasten the hinged roller to the shower panel via female portions 91 on left and right hinge portions and female portions on the door panels. FIG. 8D shows the rear of the single hinged roller.

The spring is fitted on the spring pin 85 and is chosen for the size and resistance needed. The spring loaded single hinged roller allows to easily insert and remove the door panels from the rails of the shower.

FIG. 9 is a side plan view of the double hinged roller affixed to the top of a slidable panel and of the single hinged roller affixed to the bottom of the same panel, both rollers being inserted in a corresponding top and bottom rail of the shower.

Example dimensions for the overall size of the double and single hinged rollers are as follows: 127 mm in length, 34 to 36.50 mm in height, 18 mm in width for the hinged fastener including both a right and a left hinge portions. The wheels can have a diameter of 23.30 mm and a thickness of 8.5 mm including their back support.

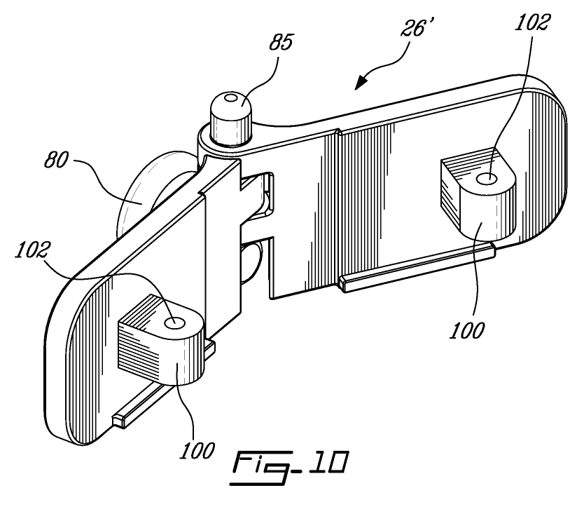

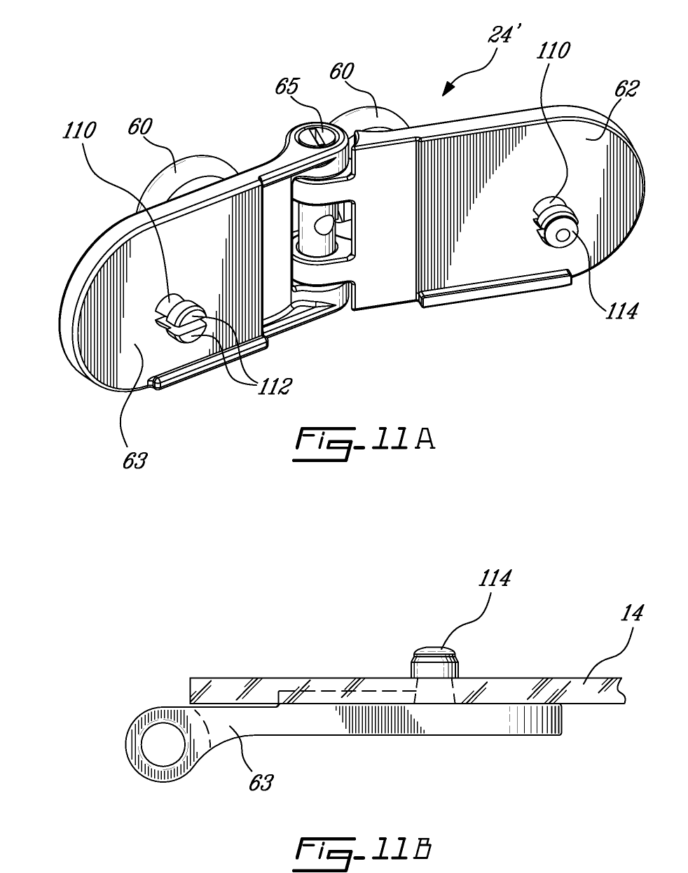

FIG. 10 is a side perspective view of a single hinged roller 26′ provided with adapters 100 for affixing the single hinged roller to the panels using a pin. It is provided with female members 102, in this case, a protuberance 100 with a vertical cylindrical passage 102, to fasten it to the shower door using a male member inserted in both the female member of the hinged roller and a female member of the sliding panels 14, 15. This embodiment could also be adapted for the double hinged roller.

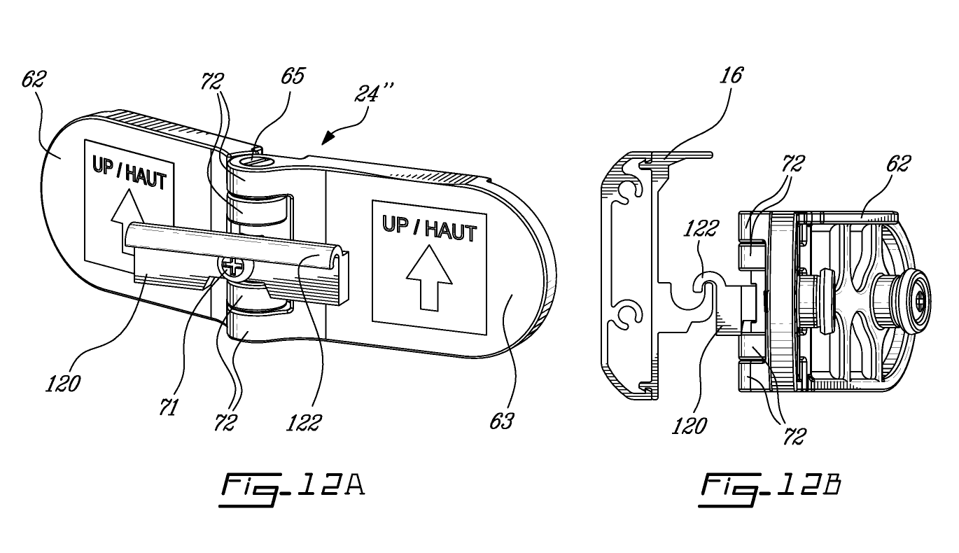

FIG. 11 shows the double hinged roller 24′ comprising snap-on protrusions 110 for snapping into female elements of the sliding panels. This embodiment could also be adapted for the single hinged roller. The door panels are snapped into the hinged roller using protrusions 110 on the hinged roller and holes in the door panels. As shown in FIG. 11A, the protrusions 110 are made of two separate portions 112 which must be bent inwards slightly to enter the holes in the door panels but which resiliently catch on the other side of the panel once it is inserted. A plug 114 is inserted in between the two portions 112 and covers the end of the protrusions 110 to prevent disassembly. FIG. 11B shows the right hinge portion 63 assembled to the panel 14 with the protrusion 110 inserted in a hole of the panel and the plug 114 fitted on the protrusion.

The hinged fastener for a shower door having two juxtaposed door panels therefore comprises two hinge portions each adapted to be attached to one of the two door panels, said hinge portions being pivotally connected to one another and pivoting about a hinge pivot axis located between said two door panels to form a hinge and at least one mounting assembly pivotally connected to a mounting pivot axis, parallel to the hinge pivot axis, and pivoting thereabout, independently of the hinge portions, the mounting assembly being engaged with a shower rail for simultaneous displacement of the door panels of the shower door relative to the shower rail. The hinge pivot axis and the mounting pivot axis can be one and the same axis.

Advantageously, the hinge portions have complementing barrel portions forming a barrel when the hinge portions are pivotally connected, and further comprising a pin for securing connection of the hinge portions by being received in said barrel. As will be readily understood, the hinge could be formed in another way as long as the panels are then able to pivot about a same pivot axis located in between the panels.

The roller assembly of the displacement assembly, if any, can have one or more wheels.

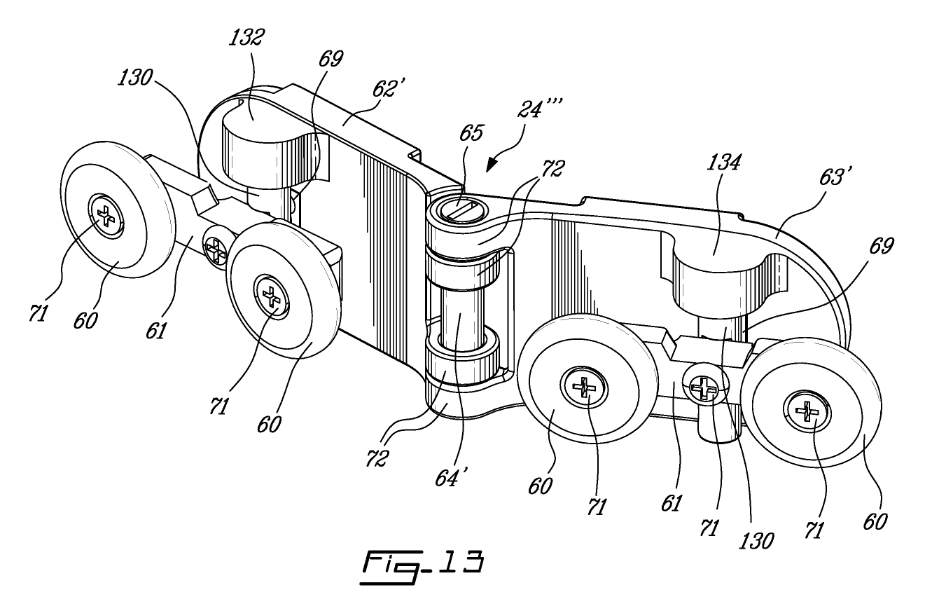

In alternate embodiments where the hinged fastener does not have a roller assembly, the mounting assembly can also use the pin of the hinge to provide a displacement assembly which does not have wheels. Such an embodiment is shown in FIGS. 12A and 12B. A support bare 120 has an inversed U-shaped section 122 which is received in the U-shaped portion of the rail 16. A pad (not shown) can be provided on the inversed U-shaped section 122 to smoothen displacement of the assembly on the rail 16 or a water insoluble, cleaning product insoluble grease can be used on one or both U-shaped sections to smoothen displacement. Such grease products are typically used in boating.

As shown in FIG. 13, the pin 64′ could also only be used to provide folding of the hinged portions with respect to one another. The wheels 71 would then each be provided on an additional rotatable pin 130 provided on protruding sections 132, 134 of hinge portions 62′ and 63′. Each hinge portion would then be wheeled while the pivot axis of the hinged fastened would not be provided with a roller assembly. The additional rotatable pins 130 would be vertical, and therefore substantially parallel to one another and to the pin 64′. All pins therefore provide a substantially parallel pivot axis.

Preferably, all slidable panels referred to in the present description are glass panels which can be held in a frame or not. A frame on the door panel is not necessary. As will be readily understood by one skilled in the art, the panels can be made of any material such as plastic, metal, glass, etc. If the panels are held in a frame, the frame can be made of any material, such as aluminum.

In the present description, all female members can be replaced by male members and corresponding male members modified accordingly and vice-versa.

The embodiments of the invention described above are intended to be exemplary only. The scope of the invention is therefore intended to be limited solely by the scope of the appended claims.

What is claimed is:

1. A hinged fastener for a shower door having two juxtaposed door panels, comprising:
two hinge portions each adapted to be attached to one of said two door panels, said hinge portions being pivotally connected to one another and pivoting about a hinge pivot axis located between said two door panels to form a hinge; and
at least one mounting assembly pivotally connected to a mounting pivot axis, parallel to said hinge pivot axis, said mounting assembly pivoting about said mounting pivot axis, independently of said hinge portions, said mounting assembly being engaged with a shower rail for simultaneous displacement of said door panels of said shower door relative to said shower rail.

2. The hinged fastener of claim 1, wherein said at least one mounting assembly is one mounting assembly and said hinge pivot axis is said mounting pivot axis.

3. The hinged fastener of claim 2 wherein said hinge portions have complementing barrel portions forming a barrel when said hinge portions are pivotally connected, and further comprising a pin for securing connection of said hinge portions by being received in said barrel.

4. The hinged fastener of claim 3 wherein said complementing barrel portions are at least one knuckle, said knuckle on one of said hinge portions being adapted to be interleaved with a complementing knuckle on an other one of said hinge portions to form said barrel.

5. The hinged fastener of claim 3 wherein said pin has an exposed tip adapted to cause a displacement of said mounting assembly with respect to said hinge portions.

6. The hinged fastener of claim 1, wherein said mounting assembly further comprises a roller assembly having at least one wheel and a wheel support pivotally connected to said mounting pivot axis, said at least one wheel being engaged with said shower rail for rolling said door panels.

7. The hinged fastener of claim 2, wherein said mounting assembly further comprises a roller assembly having at least one wheel and a wheel support pivotally connected to said mounting pivot axis, said at least one wheel being engaged with said shower rail for rolling said door panels.

8. The hinged fastener of claim 7, wherein said roller assembly comprises two wheels secured side-by-side on said wheel support for simultaneous engagement with said rail.

9. The hinged fastener of claim 1, wherein said hinge portions further comprise a snap-on protrusion to attach each said hinge portion to one of said two door panels.

10. The hinged fastener of claim 3, wherein said pin is a spring-loaded pin adapted to cause a displacement of said mounting assembly with respect to said hinge portions.

11. The hinged fastener of claim 2, wherein said mounting assembly further comprises a displacement assembly having an inversed U-shaped section and a displacement support pivotally connected to said mounting pivot axis, said inversed U-shaped section being engaged with said shower rail for displacing said door panels.
